(19) United States
(12) Patent Application Publication
(10) Pub. No.: US 2020/0381149 A1
(43) Pub. Date: Dec. 3, 2020

(54) INSULATING ASSEMBLY

(71) Applicant: Honeywell International Inc., Morris Plains, NJ (US)

(72) Inventors: Reginald Alan Byrd, Summerville, SC (US); Steven Douglas Shuman, Moncks Corner, SC (US)

(21) Appl. No.: 16/423,857

(22) Filed: May 28, 2019

(51) Int. Cl. H01B 17/56

(52) U.S. Cl. CPC H01B 17/56

(57) ABSTRACT

An insulating assembly for electrically insulating equipment and a method of manufacturing the same are provided herein. The insulating assembly is an insulating blanket having a first material having a defined shape with an inner region, an outer region, and an outer perimeter. The first material defines a plurality of slots having at least two edges extending inward from the outer perimeter towards the inner region. The plurality of slots extends inward from the outer perimeter of the insulating blanket define the outer region and the inner region. The outer region has a plurality of flap members and the inner region has a center member.

### TECHNOLOGICAL FIELD

This disclosure generally relates to an insulating assembly and, more particularly, to the configurations of electrically insulating blankets, as well as the geometry of a slotted insulating blanket.

### BACKGROUND

Commonly, rubber insulating blankets of the type noted above are made to conform to standard specifications, as exemplified by ASTM D 1048-99, which is entitled “Standard Specification for Rubber Insulating Blanket”, which was published in September 1999 by ASTM of West Conshohocken, Pa., and the content of which is incorporated herein by reference. Herein, as in ASTM D 1048-99, the term “rubber” is “a generic term that includes elastomers and elastomer compounds regardless of origin.”

Commonly, a rubber insulating blanket of the type noted above is generally square or otherwise generally rectangular, to have two longitudinal edges, two transverse edges, and four corners. Commonly, a rubber insulating blanket of the type noted above has multiple eyelets, which include an eyelet near each corner and an eyelet near the middle of each longitudinal edge. Commonly, a rubber insulating blanket of the type noted above has a generally uniform thickness, except for a “beaded edge” defined in ASTM D 1048-99 as “a narrow border of thicker rubber which extends completely around the outer edges of the blanket.”

Typically, insulating blankets (or sheets) of natural and synthetic rubber are used by workers, such as electrical line workers and industrial electricians, to cover live electrical equipment, such as conductors, apparatus, or circuits, for protection against electrical shock hazards. The applicant has identified several deficiencies and problems associated with conventional grounding devices. Through applied effort, ingenuity, and innovation, many of these identified problems have been solved by developing solutions that are included in embodiments of the present invention, many examples of which are described in detail herein.

Electrically insulating blankets that are square or rectangle are limited in their ability to uniformly cover a piece of electrical equipment that utility workers generally encounter. For example, wrapping a weather head or an electrical insulator with a square blanket may not uniformly cover the devices. In addition, such electrically insulating blankets are bulky and tend to bulge when they are used to wrap equipment, which can obstruct the utility worker's view and work area.

This Background section is intended to introduce the reader to various aspects of art that may be related to various aspects of the present disclosure, which are described and/or claimed below. This discussion is believed to help provide the reader with background information to facilitate a better understanding of the various aspects of the present disclosure. Accordingly, it should be understood that these statements are to be read in this light, and not as admissions of prior art.

### BRIEF SUMMARY

Apparatus, systems, and methods described herein relate to electrically insulating protection devices, insulating assemblies therefor, and associated methods for the same. In some embodiments, an insulating assembly for electrically insulating equipment includes a slotted insulating blanket with the rubber portion having flap members with flared ends. Such an insulating assembly may enhance the functionality of the insulating blanket and make it easier to fasten about electrical equipment. The insulating assembly described herein may minimize the amount of bulging a conventional square or rectangular blanket poses when being installed about electrical equipment. Thus, the insulating assembly described herein may enable utility workers to fold the insulating blanket over electrical equipment to encapsulate the equipment on all sides, thereby substantially fully covering the live electrical equipment and providing improved protection against electrical shock hazards.

In some embodiments, the insulating blanket may include an outer perimeter and define a plurality of slots extending inward from the outer perimeter of the insulating blanket towards a center point defined within an inner region of the insulating blanket. The insulating blanket may have a defined shape. Edges of each of the plurality of slots may define a longitudinal axis extending inward from the outer perimeter through the center of the slot. The edges may define one of a zero convergence or a non-zero convergence from the outer perimeter towards the center point defined on the inner region of the insulating blanket. A length of each slot of the plurality of slots may extend inward from the outer perimeter of the insulating blanket towards the center point defined on the inner region of the insulating blanket by a predefined portion of the distance between the outer perimeter and the center point defined within the inner region of the insulating blanket. A terminating point of each of the plurality of slots may define a bend relief cut having a radius. The plurality of slots extending inward from the outer perimeter of the insulating blanket towards the center point defined within the inner region of the insulating blanket may define a center member and a plurality of flap members.

In some embodiments, each of the plurality of slots may have parallel edges. In this embodiment, the edges of a corresponding slot of the plurality of slots extend inward from the outer perimeter to define a zero convergence from the outer perimeter towards the center point defined within the inner region of the insulating blanket.

In some embodiments, each of the plurality of slots may have tapered edges. In this embodiment, the edges of a corresponding slot of the plurality of slots extend inward from the outer perimeter to define a non-zero convergence from the outer perimeter towards the center point defined within the inner region of the insulating blanket.

In some embodiments, each flap member may have one or more eyelets provided at defined positions that enable a fastening member to fasten the plurality of flap members together.

In some embodiments, the defined shape may correspond to a regular polygon. The outer perimeter may comprise at least three corners from where at least three slots of the plurality of slots extend inward towards the center point defined on the inner region of the insulating blanket.

In some embodiments, a fastening member may be configured to fasten the plurality of flap members when the plurality of flap members is wrapped around a live electrical equipment. The fastening member may be one of an integrated member of the insulating blanket or a separate member from the insulating blanket.

In some embodiments, the fastening member may correspond to one of a clamp pin, a blanket button, a magnetic blanket button, or a hook and pile fastener.

In some embodiments, the defined shape may correspond to a shape of one of a circle or a polygon.

In accordance with another aspect of the disclosure, an insulating assembly is disclosed that may comprise an insulating blanket of a defined shape and having an outer perimeter, wherein the insulating blanket defines a plurality of slots extending inward from the outer perimeter of the insulating blanket towards one or more points defined within an inner region of the insulating blanket in a defined pattern. Longitudinal edges of each of the plurality of slots extending inward from the outer perimeter may define one of a zero convergence or a non-zero convergence from the outer perimeter towards the one or more points defined on the inner region of the insulating blanket. A length of each slot of the plurality of slots may extend inward from the outer perimeter of the insulating blanket towards the one or more points defined on the inner region of the insulating blanket by a predefined portion of distance between the outer perimeter and the one or more points defined on the inner region of the insulating blanket. The plurality of slots extending inward from the outer perimeter of the insulating blanket towards the one or more points defined on the inner region of the insulating blanket may define a center member and a plurality of flap members. The insulating assembly may further comprise a fastening member configured to fasten the plurality of flap members when the plurality of flap members is wrapped around a live electrical equipment.

In some embodiments, the plurality of slots may extend inward from the outer perimeter of the insulating blanket towards one or more points defined on the inner region of the insulating blanket in the defined pattern.

In some embodiments, the one or more points may correspond to a single point defined at a center of the inner region of the insulating blanket. In such embodiments, the plurality of slots extending from the outer perimeter may be aligned towards a center of the inner region of the insulating blanket. In alternate embodiments, the one or more points may correspond to a set of off-center points defined within the inner region of the insulating blanket in a pattern. In such embodiments, the plurality of slots may be off-centered, extending from the outer perimeter of the insulating blanket. In some embodiments, a defined pattern corresponds to a closed regular shape.

In some embodiments, the closed regular shape of the defined pattern may define a shape of the center member of the insulating blanket. Accordingly, a shape of the center member of the insulating blanket corresponds to one of a circle, an oval, or a polygon.

In some embodiments, one of the zero convergence or the non-zero convergence defined by the longitudinal edges of each of the plurality of slots may define a shape of each of the plurality of flap members.

In some embodiments, a perimeter line between at least two adjacent bend relief cuts corresponding to at least two adjacent terminating points of at least two slots of the plurality of slots defines a hinge line between the center member and a flap member of the plurality of flap members. In some embodiments, the outer perimeter comprises one or more corners based on the defined shape of the insulating blanket.

In some embodiments, the insulating assembly may further include a rigid frame member. The rigid frame member may form a cap region located within the inner region of the insulating blanket. An outer perimeter of the rigid frame member may define a live hinge or hinge line. The plurality of slots may extend toward a centroid of the rigid frame member.

In some embodiments, the fastening member may correspond to one of a clamp pin, a blanket button, a magnetic blanket button, a hook, and a pile fastener. In some embodiments, the fastening member is an integrated member of the insulating assembly.

In some embodiments, a terminating point of each of the plurality of slots defines a bend relief cut having a radius.

In some embodiments, each of the plurality of slots may have parallel edges when the longitudinal edges of a corresponding slot of the plurality of slots extend inward from the outer perimeter to define a zero convergence from the outer perimeter towards a center point defined on the inner region of the insulating blanket.

In some embodiments, each of the plurality of slots may have tapered edges when the edges of a corresponding slot of the plurality of slots extending inward from the outer perimeter define a non-zero convergence from the outer perimeter towards a center point defined within the inner region of the insulating blanket.

The above summary is provided merely for purposes of summarizing some example embodiments to provide a basic understanding of some aspects of the invention. Accordingly, it will be appreciated that the above-described embodiments are merely examples and should not be construed to narrow the scope or spirit of the invention in any way. It will be appreciated that the scope of the invention encompasses many potential embodiments in addition to those here summarized, some of which will be further described below.

### BRIEF DESCRIPTION OF THE DRAWINGS

Having described certain example embodiments of the present disclosure in general terms above, reference will now be made to the accompanying drawings. The components shown in the figures may or may not be present in certain embodiments described herein. Some embodiments may include fewer (or more) components than those shown in the figures.

FIG. 1A is a top view of an insulating blanket in accordance with a first example embodiment of the present disclosure;

FIG. 1B is a top view of an insulating blanket in accordance with a second example embodiment of the present disclosure;

FIG. 1C is a top view of an insulating blanket in accordance with a third example embodiment of the present disclosure;

FIG. 1D is a top view of an insulating blanket in accordance with a fourth example embodiment of the present disclosure;

FIG. 1E is a top view of an insulating blanket in accordance with a fifth example embodiment of the present disclosure;

FIG. 1F is a top view of an insulating blanket in accordance with a seventh example embodiment of the present disclosure;

FIG. 1G is a top view of an insulating blanket in accordance with an eighth example embodiment of the present disclosure;

FIG. 2A is a first type of fasteners in accordance with a first example embodiment of the present disclosure;

FIG. 2B is a second type of fasteners in accordance with a second example embodiment of the present disclosure;

FIG. 2C is a third type of fasteners in accordance with a third example embodiment of the present disclosure;

FIG. 2D is a fourth type of fasteners in accordance with a fourth example embodiment of the present disclosure;

FIG. 2E is a fifth type of fasteners in accordance with a fifth example embodiment of the present disclosure;

FIG. 2F is a sixth type of fasteners in accordance with a sixth example embodiment of the present disclosure;

FIG. 3A shows a perspective view of a weather head;

FIG. 3B shows a perspective view of a weather head wrapped in an insulating blanket in accordance with an example of the present disclosure; and

FIG. 3C shows a perspective view of a weather head wrapped in an insulating blanket in accordance with another example of the present disclosure.

Like reference symbols in the various drawings indicate like elements.

### DETAILED DESCRIPTION

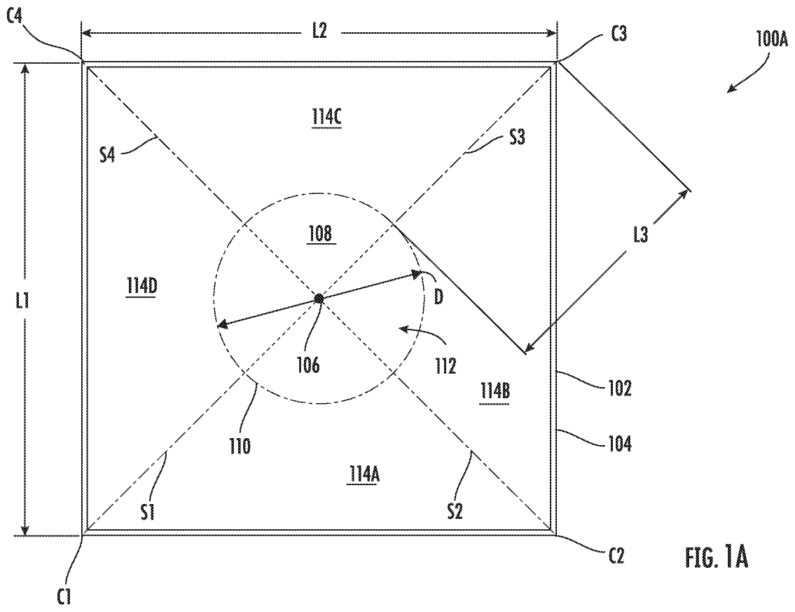

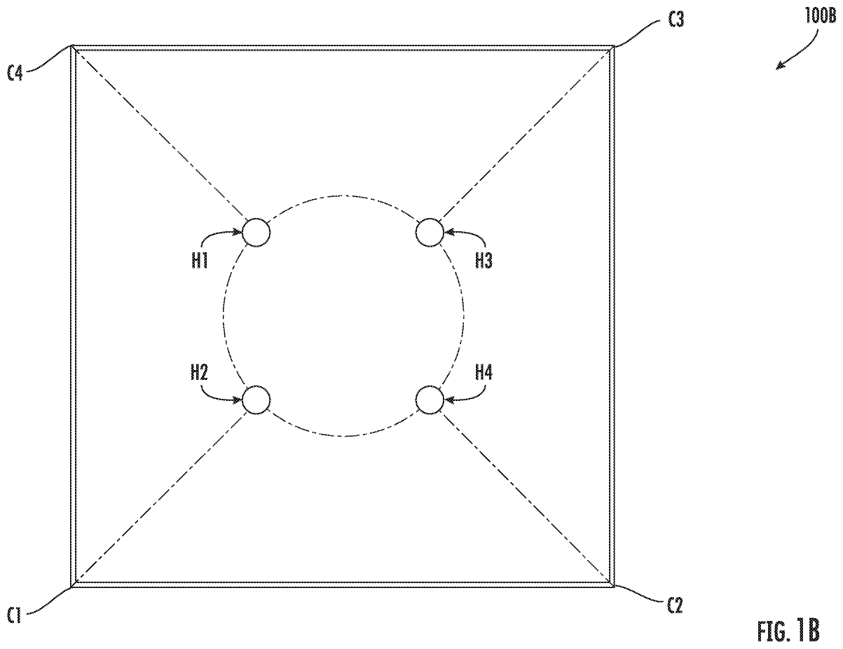

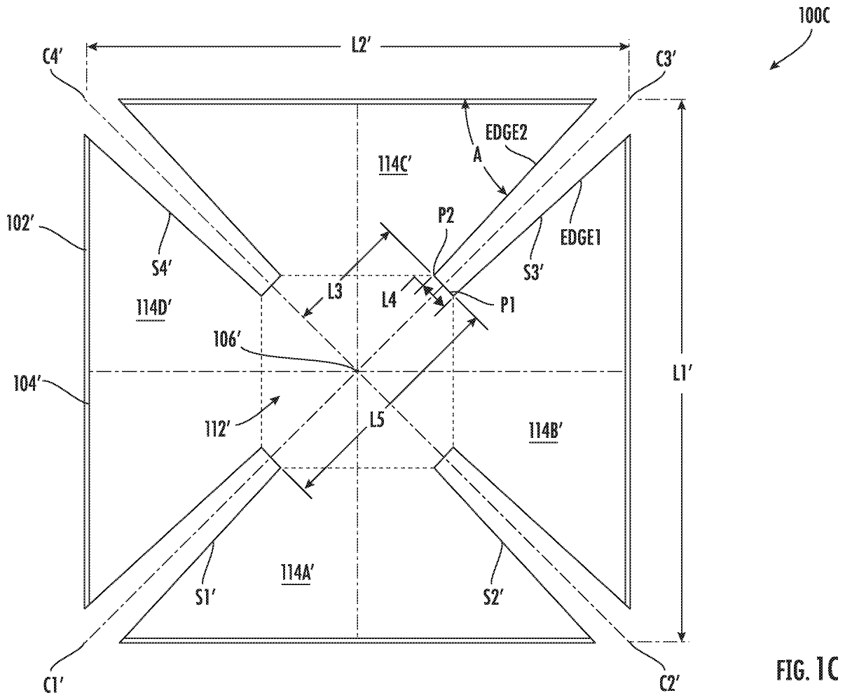

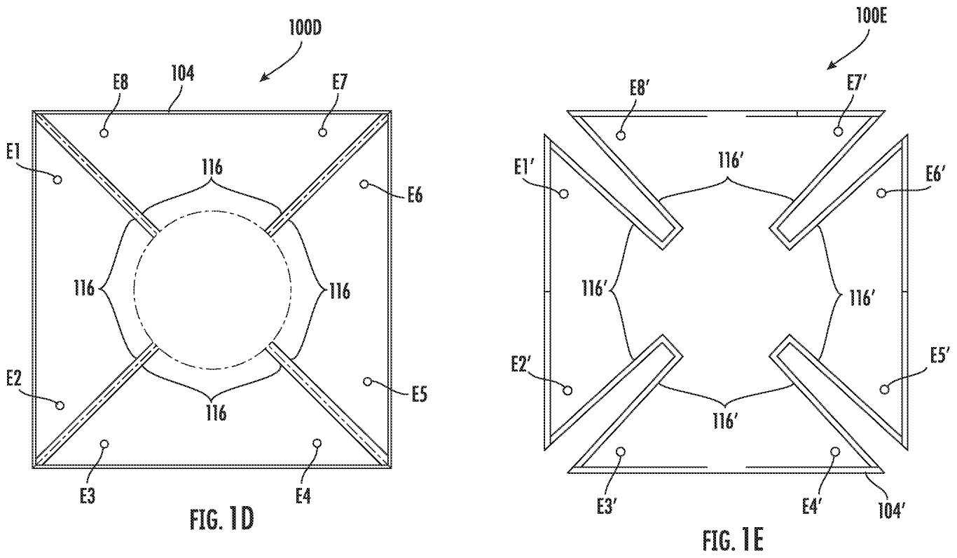

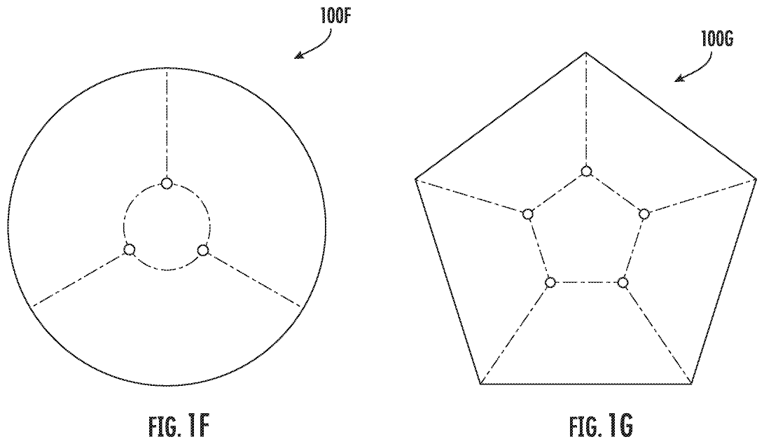

Referring to FIGS. 1A to 1G, insulating blankets 100A to 100G, as insulating blankets for protection of utility workers against electrical shocks and related hazards, are shown. While described herein with reference to a specific structure of example insulating blankets 100A to 100G, the present disclosure contemplates that the embodiments described herein may be equally applicable to other designs and structures of insulating blankets. The present disclosure appreciates that insulating blankets 100A to 100G may refer to a particular implementation, shape, and configuration, however the present disclosure contemplates that the insulating blankets 100A to 100G may be in various designs, form factors, dimensions, and the like based upon the intended application of the insulating blankets, such as insulating blankets 100A and 100C, shown in FIGS. 1A and 1C, for example.

FIGS. 1A to 1G show top views of various example insulating blankets, according to example embodiments. With reference to FIG. 1A, there is shown an insulating blanket 100A having an outer perimeter 102. The outer perimeter 102 of the insulating blanket 100A, in an embodiment, as shown in FIG. 1A, encompasses a square shape, which has two longitudinal edges L1 about two to four feet long, with the same length as two transverse edges L2 about two to four feet long, and four corners C1 to C4.

Similarly, it may be noted that outer perimeter 102′ of the insulating blankets 100B and 100C, in other embodiments, as shown in FIGS. 1B and 1C, also encompass a defined shape, such as a square shape, so as to have two longitudinal edges L1 about two to four feet long, with the same length as two transverse edges L2 about two to four feet long, and four corners C1 to C4. However, the present disclosure should not be limited to the outer perimeter 102 encompassing square shapes only, but may be further contemplated that the outer perimeter 102 may encompass other shapes as well, such as a circular shape, an oval shape, or another polygon shape, such as the pentagon shape, as shown in FIGS. 1F and 1G. In some embodiments, the outer perimeter may comprise at least three corners from where at least three slots of the plurality of slots may extend inward towards a center point defined within an inner region of an insulating blanket.

The insulating blanket 100A may define a plurality of slots, such as S1 to S4, extending inward from an outer perimeter 102, such as the corners C1 to C4, of the insulating blanket 100A towards a center point 106 defined within an inner region 108 of the insulating blanket 100A. Such plurality of slots S1 to S4 may be defined as a plurality of cuts extending inward from the corners C1 to C4 of the insulating blanket 100A towards a center point 106 to a defined length L3. In an embodiment, the defined length L3 may be a predefined portion of the distance between each corner of the outer perimeter 102 and the center point 106 defined on the inner region 108 of the insulating blanket 100A. Accordingly, the inner region 108 may acquire a defined shape, for example a circular shape, with a defined diameter D. In an embodiment, the inner region 108 may acquire the defined shape, for example, the circular shape, by defining a hinge line 110 encompassing the terminal points of the plurality of slots S1 to S4 with defined length L3. The hinge line 110 between a center member 112 and a flap member of a plurality of flap members 114A to 114D may be a perimeter line between at least two adjacent terminating points or bend relief cuts corresponding to at least two adjacent terminating points of at least two slots of the plurality of slots S1 to S4.

In some embodiments, the length of the two longitudinal edges L1 and the two transverse edges L2 may be, for example, 36 inches each. The plurality of slots S1 to S4 may be defined as a plurality of cuts extending inward from the corners C1 to C4 of the insulating blanket 100A towards the center point 106 to the defined length L3 each which may be, for example, 17.45 inches each. Accordingly, the inner region 108 may acquire a defined shape, for example, a circular shape, with the defined diameter D, for example, comprising 16 inches.

Thus, the plurality of slots S1 to S4 extending inward from the outer perimeter 102 of the insulating blanket 100A towards the center point 106 defined within the inner region 108 of the insulating blanket 100A defines the center member 112 and the plurality of flap members 114A to 114D.

In some embodiments, as shown in FIG. 1A, each of the longitudinal and transverse edges L1 and L2 of the insulating blanket 100A may be a beaded edge 104 having a narrow border of thicker rubber. In some embodiments, as shown in FIG. 1D, each of the longitudinal and transverse edges L1 and L2 of the insulating blanket 100D may be a beaded edge 104 having a narrow border of thicker rubber. Further, each of the edges of the plurality of slots S1 to S4 may also be a beaded edge 116 having a narrow border of thicker rubber. In certain embodiments, although not shown, the narrow border may be widened at each portion near the corners C1 to C4 so as to define a pad reinforcing the insulating blanket 100D where eyelets E1 to E8 are provided. It may be noted that each flap member 114A to 114D may have one or more eyelets provided at defined positions that enable a fastening member to fasten the plurality of flap members 114A to 114D upon wrapping around a live electrical equipment. Such beaded edges 104 and 116 having a narrow border of thicker rubber may provide additional durability to the edges, slots, and eyelets for added strength and tear-resistance.

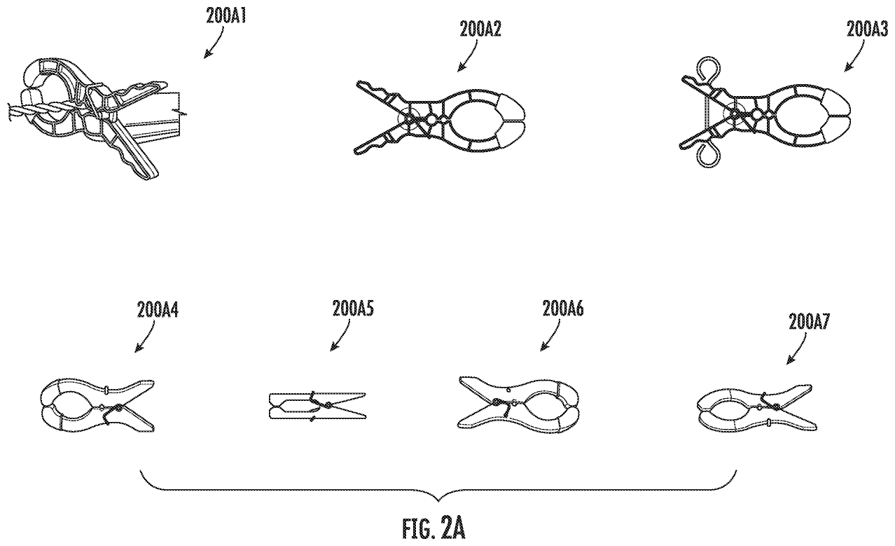

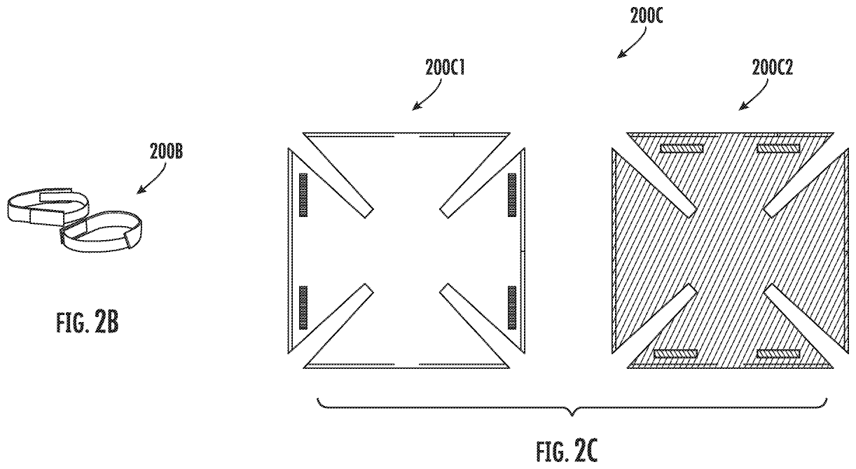

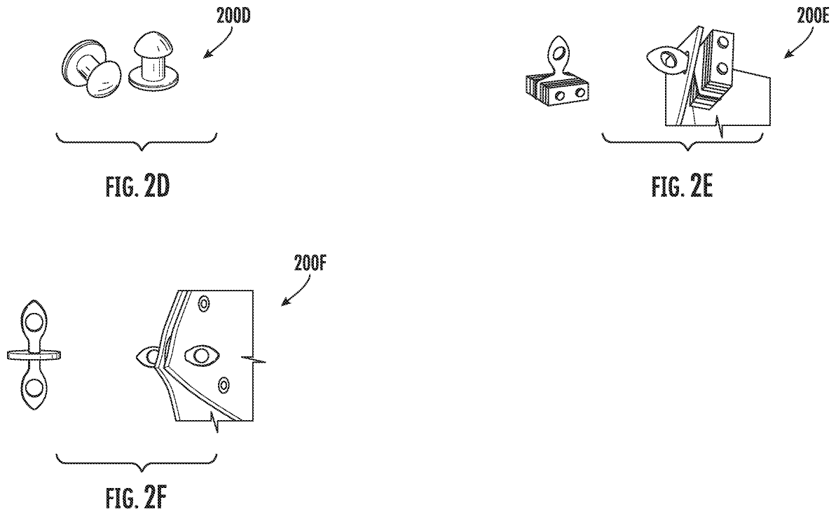

Further, the insulating blanket 100A, as shown in FIG. 1A, may not have any eyelet. However, the insulating blanket 100D, as shown in FIG. 1D, may have multiple eyelets, such as eight eyelets. It may be noted that the presence and absence of the eyelets may depend on the type of fastener to be used for fastening the insulating blankets 100A or 100D. For example, if the fasteners to be used are clamp pins or hook and pile fasteners, shown in FIGS. 2A and 2B, then the eyelets may not be required, in case of, for example, the insulating blanket 100A. In other examples, if the fasteners to be used are hook and pile fasteners integrated into an insulating blanket, shown in FIG. 2C, then the eyelets may not be required for fastening. However, in other examples, if the fasteners to be used are blanket buttons or magnetic blanket buttons, shown in FIGS. 2D to 2F, then the eyelets may be required for fastening, in case of, for example, the insulating blanket 100D.

In some embodiments, as shown in FIG. 1B, the insulating blanket 100B which is similar to the insulating blanket 100A, may have additional members, such as bend relief cuts H1 to H4 of a predefined radius, defined at the terminating point of each of the plurality of slots S1 to S4. Such bend relief cuts H1 to H4 may also have beaded edges having narrow borders (not shown) of thicker rubber.

With reference to FIG. 1C, there is shown an insulating blanket 100C having an outer perimeter 102′. The outer perimeter 102′ of the insulating blanket 100C, in an embodiment as shown in FIG. 1C, encompasses a square shape, so as to have two longitudinal edges L1′ about two to four feet long, with the same length as two transverse edges L2′ about two to four feet long, and four corners C1′ to C4′. Similarly, it may be noted that the outer perimeter 102′ of the insulating blanket 100E, in other embodiment, as shown in FIG. 1E, also encompasses a defined shape, such as a square shape, so as to have two longitudinal edges L1′ about two to four feet long, with the same length as two transverse edges L2′ about two to four feet long, and four corners C1′ to C4′. However, as described above the present disclosure should not be limited to the outer perimeter 102′ encompassing square shapes only, but may be further contemplated that the outer perimeter 102′ may encompass other shapes as well, such as a circular shape or another polygon shape, such as the pentagon shape, as shown in FIGS. 1F and 1G.

The insulating blanket 100C may define a plurality of slots, such as S1′ to S4′ having at least a width L4, extending inward from an outer perimeter 102′, such as the corners C1′ to C4′, of the insulating blanket 100C towards a point, such as a center point 106′, defined within an inner region of the insulating blanket 100C. As shown in FIG. 1C, the longitudinal edges of each of the plurality of slots S1′ to S4′ extending inward from the outer perimeter 102′ may define a non-zero convergence from the outer perimeter 102′ towards the center point 106′ defined on the inner region of the insulating blanket 100C. For example, as shown in FIG. 1C, longitudinal edges Edge1 and Edge2 of the slot S3′ extend inward from the corner C3′ of the outer perimeter 102′. The longitudinal edges Edge1 and Edge2 may be tapered and define a non-zero convergence from the corner C3′ of the outer perimeter 102′ towards the center point 106′ defined on the inner region of the insulating blanket 100C. The longitudinal edges Edge1 and Edge2 are non-parallel (or tapered) and hence, tend to converge while extending towards the center point 106′ at a defined angle A with respect to the longitudinal edges L1′ and the adjacent transverse edge L2′, respectively. The longitudinal edges Edge1 and Edge2 converge and extend towards the center point 106′ until points P1 and P2, respectively, such that a perpendicular distance of the line joining the points P1 and P2 is at a length L3′ from the center point 106′. As mentioned earlier, the length of the line joining the points P1 and P2 may be the width L4, which is the minimum distance between the longitudinal edges Edge1 and Edge2. For brevity, only the slot S3′ is described herein. Other slots S1′, S2′, and S4′ also converge and extend towards the center point 106′ from respective corners in a similar manner, as described for the slot S3′.

In alternate embodiments (not shown), the insulating blanket 100C may define a plurality of slots, such as S1′ to S4′ having a uniform width L4, extending inward from an outer perimeter 102′, such as the corners C1′ to C4′, of the insulating blanket 100C towards a point, such as a center point 106′, defined within an inner region of the insulating blanket 100C. As shown in FIG. 1C, longitudinal edges of each of the plurality of slots S1′ to S4′ extending inward from the outer perimeter may define a zero convergence from the outer perimeter 102′ towards the center point 106′ defined on the inner region of the insulating blanket 100C. The longitudinal edges Edge1 and Edge2 are parallel and hence, do not tend to converge while extending towards the center point 106′ at the defined angle A with respect to the longitudinal edges L1′ and the adjacent transverse edges L2′, respectively. The longitudinal edges Edge1 and Edge2 run parallel without convergence (or non-tapered) and extend towards the center point 106′ until points P1 and P2, respectively, such that a perpendicular distance of the line joining the points P1 and P2 is at a length L3′ from the center point 106′. As mentioned earlier, the length of the line joining the points P1 and P2 may be the width L4, which is the uniform width between the longitudinal edges Edge1 and Edge2. Other slots S1′, S2′, and S4′ also extend towards the center point 106′ from respective corners in a similar manner, as described for the slot S3′.

In an example use case, the length of the two longitudinal edges L1′ and the two transverse edges L2′ may be, for example, 36 inches each. The longitudinal edges Edge1 and Edge2 are non-parallel and tend to converge while extending towards the center point 106′ at defined angle A, which may be 47 degrees (permissible range from 40 degrees to 50 degrees), with respect to the longitudinal edges L1 and the adjacent transverse edge L2, respectively. The longitudinal edges Edge1 and Edge2 converge and extend towards the center point 106′ until points P1 and P2, respectively, such that a perpendicular distance of the line joining the points P1 and P2 is at a length L3′, which may be 8 inches, from the center point 106′. The length of the line joining the points P1 and P2 may be L4, which may be 2 inches, which is the minimum distance between the longitudinal edges Edge1 and Edge2.

Thus, the plurality of slots S1′ to S4′ extending inward from the outer perimeter 102′ of the insulating blanket 100C towards the center point 106′ defines a center member 112′ and a plurality of flap members 114A′ to 114D′.

In some embodiments, as shown in FIG. 1C, each of the longitudinal and transverse edges L1′ and L2′ of the insulating blanket 100C may be a beaded edge 104′ having a narrow border of thicker rubber. In some embodiments, as shown in FIG. 1E, each of the longitudinal and transverse edges L1′ and L2′ of the insulating blanket 100E may be a beaded edge 104′ having a narrow border of thicker rubber. Additionally, each of the edges of the plurality of slots S1′ to S4′ may also be a beaded edge 116′ having a narrow border of thicker rubber. In certain embodiments, although not shown, the narrow border may be widened at each portion near the corners C1′ to C4′ so as to define a pad reinforcing the insulating blanket 100E where eyelets E1′ to E8′ are provided. It may be noted that each flap member 114A′ to 114D′ may have one or more eyelets provided at defined positions that enable a fastening member to fasten the plurality of flap members 114A′ to 114D′ upon wrapping around a live electrical equipment. Such beaded edges 104′ and 116′ having a narrow border of thicker rubber may provide additional durability to the edges, slots, and eyelets for added strength and tear-resistance.

Further, the insulating blanket 100C, as shown in FIG. 1C, may not have any eyelet. However, the insulating blanket 100E, as shown in FIG. 1E, may have multiple eyelets, such as eight eyelets. The reason for the presence and absence of the eyelets are similar, as described above.

With reference to FIGS. 1F and 1G, there are shown two insulating blankets 100F and 100G with outer parameters encompassing a circular shape and a pentagon shape, respectively. The two insulating blankets 100F and 100G define a different number of the plurality of slots extending inward from the outer perimeter towards corresponding center points. Referring to FIG. 1F, the plurality of slots of the insulating blanket 100F defines a circular center member and three flap members. Referring to FIG. 1G, the plurality of slots of the insulating blanket 100G defines a pentagon center member and five flap members. Hence, the outer perimeter comprises zero corners (in the case of insulating blanket 100F), four corners (in the case of insulating blanket 100A), and five corners (in the case of insulating blanket 100G) based on the defined shape of the insulating blanket.

Further, a shape of the center member of an insulating blanket may correspond to one of a circle or a polygon. For example, the center member 112 may be circular (in the case of insulating blanket 100A), a polygon shape (in the case of insulating blanket 100C), or a pentagon shape (in the case of insulating blanket 100G). In general, the defined shape of an insulating blanket may correspond to a regular polygon, wherein the outer perimeter may comprise zero or at least three corners from where at least three slots of the plurality of slots extend inward towards the center point defined on the inner region of the insulating blanket.

In additional embodiments, an insulating blanket (not shown) may have a defined shape, an outer perimeter, and a plurality of slots that may extend inward from the outer perimeter of the insulating blanket. The plurality of slots may extend towards one or more points defined within an inner region of the insulating blanket in a defined pattern. In such an embodiment, the one or more points may correspond to a set of off-center points defined on the inner region of the insulating blanket in the defined pattern. The defined pattern may correspond to a closed regular shape, that further defines a shape of the center member of the insulating blanket. Accordingly, the longitudinal edges of each of the plurality of slots extending inward from the outer perimeter define one of a zero convergence or a non-zero convergence from the outer perimeter towards the one or more points defined on the inner region of the insulating blanket. Similar to the manner described in the above embodiments, a length of each slot of the plurality of slots may extend inward from the outer perimeter of the insulating blanket towards the one or more points defined on the inner region of the insulating blanket by a predefined portion of distance between the outer perimeter and the one or more points defined on the inner region of the insulating blanket.

Further, the plurality of slots extending inward from the outer perimeter of the insulating blanket towards the one or more points defined on the inner region of the insulating blanket in the defined pattern defines a center member and a plurality of flap members. In such embodiments, the plurality of slots may be off-centered extending from the outer perimeter of the insulating blanket. Additionally, a perimeter line between at least two adjacent bend relief cuts corresponding to at least two adjacent terminating points of at least two slots of the plurality of slots may define a hinge line between the center member and a flap member of the plurality of flap members.

Alternatively or additionally, the insulating blankets 100A to 100G and also insulating blankets not shown in accordance with the embodiments described above may comprise a rigid frame member that may define a cap region located in corresponding inner regions of corresponding insulating blankets that define corresponding center members. The outer perimeter of the rigid frame member may define a live hinge. In such an embodiment, a corresponding plurality of slots extends toward a centroid of the rigid frame member.

In some embodiments, the insulating blankets 100A to 100G and also insulating blankets not shown in accordance with the embodiment described above may be molded, as by injection molding or compression molding, from a suitable rubber, such as SALCOR™ rubber, for rubber insulative blankets and other insulative products, so as to have a generally uniform thickness, except for narrow borders, pads, and eyelets that have equal thicknesses, which are greater than the generally uniform thickness. For such embodiments, a die or a template may be made, so that when the rubber is compressed in its mold, die or a template may stamp out the new design of the insulating blanket, such as the insulating blankets 100A to 100G and also insulating blankets not shown, in accordance with the embodiment described above.

FIGS. 2A to 2F show different types of fasteners, according to example embodiments. Particularly, in FIG. 2A, there are shown different types of clamp pins, in FIG. 2B, there is shown a hook and pile fastener, and in FIGS. 2D to 2F, there are shown different types of blanket buttons or magnetic blanket buttons. As described above, the presence and absence of the eyelets may determine which type of fastener may be used for fastening the insulating blankets 100A to 100G. For example, in the absence of eyelets, for example in case of the insulating blankets 100A to 100C, 100F, and 100G, fasteners, such as clamp pins or hook and pile fasteners may be used. Otherwise, in the presence of eyelets, for example in case of the insulating blankets 100D and 100E, fasteners, such as blanket buttons or magnetic blanket buttons may be used.

Each fastening member from the different types of fasteners may be configured to fasten flap members, for example, 114A to 114D, of the insulating blanket 100A when the plurality of flap members 114A to 114D is wrapped around a live electrical equipment. The fastening member may be one of an integrated member of an insulating blanket, such as shown in FIG. 2C, or a separate member, such as depicted in FIGS. 2A, 2B, 2D to 2F, from the insulating blanket.

With reference to FIG. 2A, there are shown different types of clamp pin fasteners 200A1 to 200A7. The clamp pin fasteners 200A1 to 200A7 may be effectively used to hold insulating blankets and rubber cover-up in place. The clamp pin fasteners 200A1 to 200A7 may include springs for tension while extra holes in the body may be used to grip conductors and prevent line hose from sliding. The clamp pin fasteners 200A1 to 200A7 may be made of fiberglass reinforced nylon or sliver-free hardwoods. Most clamp pins have molded rubber tips to increase slip resistance.

Some clamp pins, for example, the clamp pin fasteners 200A1 to 200A3, may be designed to accommodate application using a hot stick. The ends of such clamp pins may be tapered to fit into the end of any brand clampstick. Accordingly, such clamp pins may be installed in line with the stick. Such clamp pins may be further used for applications where a 90-degree angle of application and removal is required.

With reference to FIG. 2B, there are shown fastening straps of rubber with hook and pile fasteners 200B affixed to each end. The worker may simply wrap such fastening straps around the positioned insulating blanket and press the hook and pile ends together.

With reference to FIG. 2C, there are shown hook and pile fasteners integrated into an insulating blanket 200C. Such hook and pile fasteners may be one-inch wide strips double stitched to the insulating blanket with nylon thread. In FIG. 2C, there is shown top view 200C1 of the insulating blanket 200C that depicts hook strips being stitched to a first set of opposite flap members. Further, the bottom view 200C2 of the insulating blanket 200C shows pile strips being stitched to a second set of opposite flap members. Such a positioning of the hook and pile fasteners ensures safe and fast installation and removal of the insulating blanket 200C.

With reference to FIGS. 2D and 2F, there are shown blanket buttons 200D and 200F designed to secure eyelet-style insulating blankets, such as the insulating blankets 100D and 100E. The blanket button 200D, made of plastic, may snap through the eyelet with thumb pressure on the large head. The blanket button 200F, made of polystyrene, may be a two-way button and may be inserted into the eyelets for use with a shotgun clamp stick or standard duty switch stick, for example.

With reference to FIG. 2E, there is shown a magnetic blanket button 200E designed for use in eyelets of insulating blankets, such as the insulating blankets 100D and 100E, when covering energized portions in hard-to-cover areas, like pad mounts, cubicles, switchboards, and substations. In such magnetic blanket button 200E, four permanent floating magnets may be mounted between nickel-plated steel plates. Such magnetic blanket button 200E may be applied manually, wearing rubber gloves, or with a shot-gun stick.

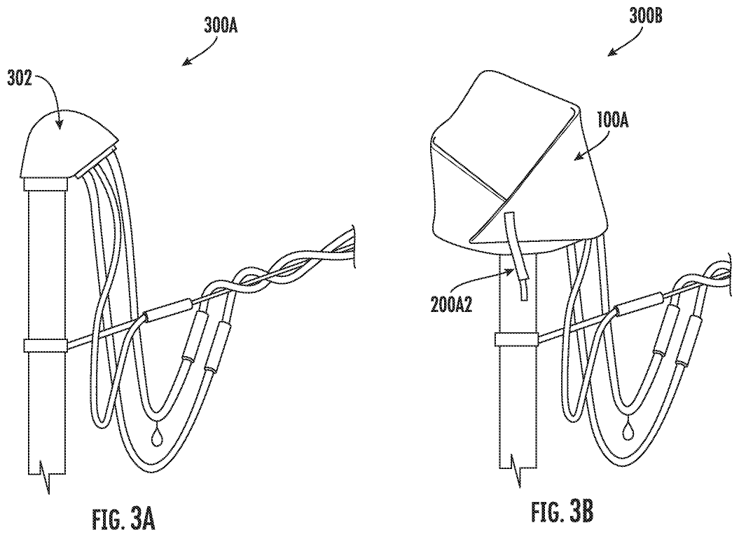

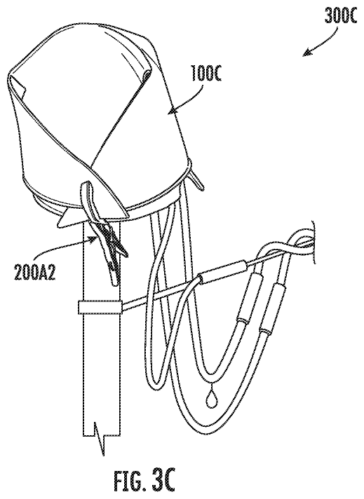

FIGS. 3A to 3C show a use case where two example insulating assemblies are used, according to example embodiments. FIG. 3A shows a use case 300A depicting a weather head 302 that is a weatherproof service drop entry point where overhead power or telephone wires enter a building, and thus, wires transition between overhead and underground cables. In case of any electrical repair, the electrical line workers may be required to insulate the weather head 302 for repairing purposes. As shown in an example, insulating assembly 300B in FIG. 3B, the insulating blanket 100A may be wrapped or draped around the weather head 302. The insulating blanket 100A may be repositioned to accommodate any wires or other obstacles. The electrical line workers may pull down each flap of the insulating blanket 100A such that the weather head 302 is suitably covered. Once positioned properly, as shown in FIG. 3B, the electrical line workers, may secure the insulating blanket 100A using one of the clamp pin fasteners 200A1 to 200A2, for example, the clamp pin fastener 200A2 (shown in FIG. 2A). Alternatively, the hook and pile fastener 200B, and hook and pile fasteners integrated into an insulating blanket 200C may also be used to secure the insulating blanket 100A.

Further, as shown in another example, insulating assembly 300C in FIG. 3C, the insulating blanket 100C may be wrapped or draped around the weather head 302. The insulating blanket 100C may be repositioned to accommodate any wires or other obstacles. The electrical line workers may pull down each flap of the insulating blanket 100C such that the weather head 302 is suitably covered. Once positioned, as shown in FIG. 3C, the electrical line workers may secure the insulating blanket 100C using one of the clamp pin fasteners 200A1 to 200A2, for example, the clamp pin fastener 200A2 (shown in FIG. 2A). Alternatively, the hook and pile fastener 200B, and hook and pile fasteners integrated into an insulating blanket 200C may also be used to secure the insulating blanket 100C.

Thus, as described in the use case pertaining to insulating the weather head 302, it may be observed how the insulating assemblies 300B and 300C may be easily wrapped around the live electrical equipment. Such insulating assemblies 300B and 300C may allow electrical utility workers more flexibility in encapsulating the live electrical equipment and in turn offer better protection from electrical hazards.

Also, it should be understood that the figures, which highlight the structure, methodology, functionality, and advantages of the present disclosure, are presented as examples only. The present disclosure is sufficiently flexible and configurable, such that it may be implemented in ways other than that shown in the accompanying figures.

Also, the section headings used herein are provided for consistency with the suggestions under 37 C.F.R. 1.77 or to otherwise provide organizational cues. These headings shall not limit or characterize the disclosure(s) set out in any claims that may issue from this disclosure. For instance, a description of a technology in the “Background” is not to be construed as an admission that certain technology is prior art to any disclosure(s) in this disclosure. Neither is the “Summary” to be considered as a limiting characterization of the disclosure(s) set forth in issued claims. Furthermore, any reference in this disclosure to “disclosure” in the singular should not be used to argue that there is only a single point of novelty in this disclosure. Multiple disclosures may be set forth according to the limitations of the multiple claims issuing from this disclosure, and such claims accordingly define the disclosure(s), and their equivalents, that are protected thereby. In all instances, the scope of the claims shall be considered on their own merits in light of this disclosure, but should not be constrained by the headings set forth herein.

Many modifications and other embodiments of the inventions set forth herein will come to mind to one skilled in the art to which these inventions pertain having the benefit of the teachings presented in the preceding descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

While various embodiments in accordance with the principles disclosed herein have been shown and described above, modifications thereof may be made by one skilled in the art without departing from the spirit and the teachings of the disclosure. The embodiments described herein are representative only and are not intended to be limiting. Many variations, combinations, and modifications are possible and are within the scope of the disclosure. Alternative embodiments that result from combining, integrating, and/or omitting features of the embodiment(s) are also within the scope of the disclosure. Accordingly, the scope of protection is not limited by the description set out above but is defined by the claims which follow, that scope including all equivalents of the subject matter of the claims. Each and every claim is incorporated as further disclosure into the specification, and the claims are embodiment(s) of the present disclosure(s). Furthermore, any advantages and features described above may relate to specific embodiments, but shall not limit the application of such issued claims to processes and structures accomplishing any or all of the above advantages or having any or all of the above features.

1. An electrically insulating blanket for covering a live electrical equipment, comprising:
a first material being electrically insulating and having a defined shape with an inner region, an outer region, and an outer perimeter, the first material defining a plurality of slots having at least two edges extending inward from the outer perimeter towards the inner region,
wherein the plurality of slots extending inward from the outer perimeter of the electrically insulating blanket define the outer region and the inner region, the outer region having a plurality of flap members and the inner region having a center member, wherein the inner region has a rigid frame member that defines a live hinge at an outer perimeter of the rigid frame member.

2. The electrically insulating blanket according to claim 1, wherein each of the plurality of slots has parallel edges.

3. The electrically insulating blanket according to claim 1, wherein each of the plurality of slots has tapered edges, wherein the at least two edges of at least one of the plurality of slots extend inward from the outer perimeter defining a non-zero convergence from the outer perimeter towards the inner region.

4. The electrically insulating blanket according to claim 1, wherein each flap member from amongst the plurality of flap members defines at least one eyelet to enable a fastening member to fasten at least two of the plurality of flap members together.

5. The electrically insulating blanket according to claim 1, wherein the defined shape corresponds to a regular polygon, wherein the outer perimeter comprises at least three corners from where at least three slots of the plurality of slots extend inward towards the inner region.

6. The electrically insulating blanket according to claim 1, further comprising a fastening member configured to fasten at least two of the plurality of flap members together.

7. The electrically insulating blanket according to claim 6, wherein the fastening member corresponds to one of a clamp pin, a blanket button, a magnetic blanket button, a hook, and a pile fastener.

8. The electrically insulating blanket according to claim 1, wherein the defined shape corresponds to one of a circular and oval shape.

9. An electrically insulating assembly for covering a live electrical equipment, comprising:
an electrically insulating blanket of a defined shape and having an outer region, an inner region and an outer perimeter, wherein the electrically insulating blanket defines a plurality of slots extending inward from the outer perimeter of the electrically insulating blanket towards one or more points defined within the inner region of the electrically insulating blanket,
wherein edges of each of the plurality of slots extend inward from the outer perimeter,
wherein the plurality of slots extending inward from the outer perimeter of the electrically insulating blanket towards the one or more points defined on the inner region of the electrically insulating blanket defines a center member and a plurality of flap members.

10. The electrically insulating assembly according to claim 9, wherein at least two of the plurality of slots extend inward from the outer perimeter of the electrically insulating blanket towards a single point within the inner region.

11. The electrically insulating assembly according to claim 9, wherein the one or more points correspond to a single point defined at a center of the inner region of the electrically insulating blanket.

12. The electrically insulating assembly according to claim 9, wherein the plurality of slots extending from the outer perimeter are in alignment.

13. The electrically insulating assembly according to claim 9, wherein the one or more points include at least two off-center points defined within the inner region.

14. The electrically insulating assembly according to claim 9, wherein the one or more points are off-center.

15. The electrically insulating assembly according to claim 9, wherein a shape of the center member of the electrically insulating blanket corresponds to one of a circle, an oval, or a polygon.

16. The electrically insulating assembly according to claim 9, wherein the outer perimeter comprises at least one corner.

17. The electrically insulating assembly according to claim 9, further comprising a rigid member in the inner region.

18. The electrically insulating assembly according to claim 9, further comprising at least one fastening member configured to fasten at least two of the plurality of flap members together.

19. The electrically insulating assembly according to claim 18, wherein the at least one fastening member corresponds to one of a clamp pin, a blanket button, a magnetic blanket button, a hook, and a pile fastener.

20. The electrically insulating assembly according to claim 9, wherein each of the plurality of slots defines a bend relief cut having a radius.
